(19) United States
(12) Patent Application Publication
(10) Pub. No.: US 2026/0110536 A1
(43) Pub. Date: Apr. 23, 2026

(54) CONSTRUCTION GRADING STICK AND METHOD THEREFOR

(71) Applicant: Amy Browen, Cambridge, MN (US)

(72) Inventor: Amy Browen, Cambridge, MN (US)

(21) Appl. No.: 18/923,261

(22) Filed: Oct. 22, 2024

(51) Int. Cl. G01C 15/08

(52) U.S. Cl. CPC G01C 15/08

(57) ABSTRACT

A construction grading stick includes a housing, a reservoir, a dispenser, and a button. The housing is elongated. The reservoir is positioned in the housing and is designed to hold a supply of marking material. The dispenser is positioned at a lower portion of the housing. The dispenser is connected to the reservoir to dispense marking material from the reservoir. The dispenser including a dispensing orifice positioned in a bottom end surface of the housing perpendicular to a longitudinal axis of the housing. The button is positioned at an upper portion of the housing. The button is connected to the dispenser to permit selective activation of the dispenser to dispense marking material out through the dispensing orifice and onto a surface on which the construction grading stick is vertically held.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to construction surveying and grading tools and more particularly pertains to a new construction grading stick that has a built-in dispenser to dispense marking material, such as chalk or paint. When performing a grading procedure for determining differing heights of ground or concrete surfaces, the job usually requires two people. One person holds a grading stick that has an electronic receiver connected to it, while the other person marks the ground at the bottom of the grading stick. This job can theoretically be done by one person, but because the grading stick is usually quite tall and unwieldly, the person cannot hold the grading stick steady for accurate marking while also reaching down to the ground to make the mark in the correct place. In addition, construction areas that have to be measured often have natural or artificial obstacles in the way of reaching the surface to be marked, such as rebar, concrete walls and blocks, and rocks and trees.

### (2) Description of Related Art Including Information Disclosed Under 37 CFR 1.97 and 1.98

The prior art relates to construction surveying and grading tools. The prior art, as best understood, does not disclose a construction grading stick that has a built-in dispenser and reservoir of marking material, such as chalk, to permit one person to both hold the construction grading stick and mark a spot at the same time.

### BRIEF SUMMARY OF THE INVENTION

An embodiment of the disclosure meets the needs presented above in a construction grading stick generally comprising a housing, a reservoir, a dispenser, and a button. The housing is elongated. The reservoir is positioned in the housing and is designed to hold a supply of marking material. The dispenser is positioned at a lower portion of the housing. The dispenser is connected to the reservoir to dispense marking material from the reservoir. The dispenser including a dispensing orifice positioned in a bottom end surface of the housing perpendicular to a longitudinal axis of the housing. The button is positioned at an upper portion of the housing. The button is connected to the dispenser to permit selective activation of the dispenser to dispense marking material out through the dispensing orifice and onto a surface on which the construction grading stick is vertically held.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a construction grading stick according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is a side view of an embodiment of the disclosure in use.

### DETAILED DESCRIPTION OF THE INVENTION

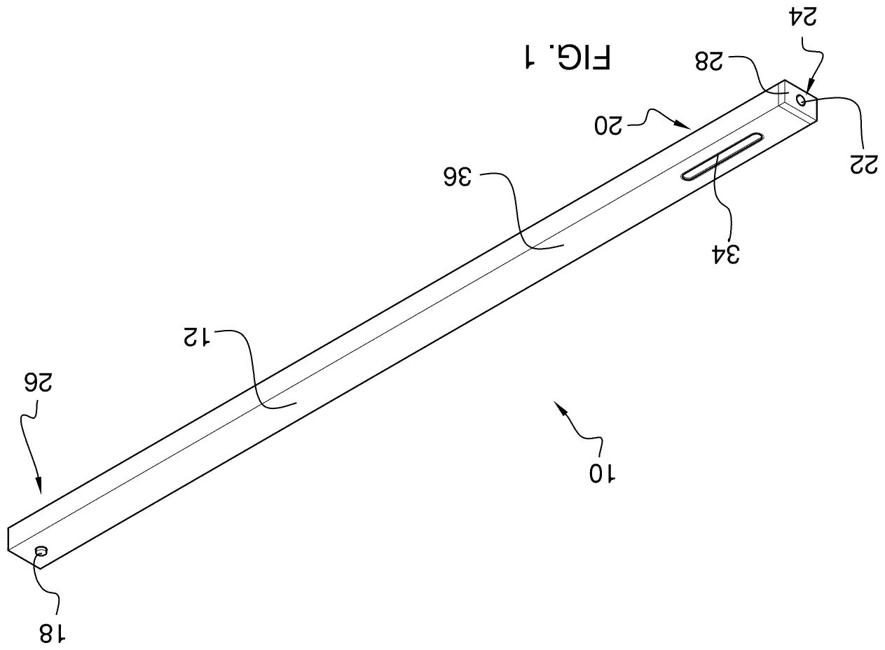

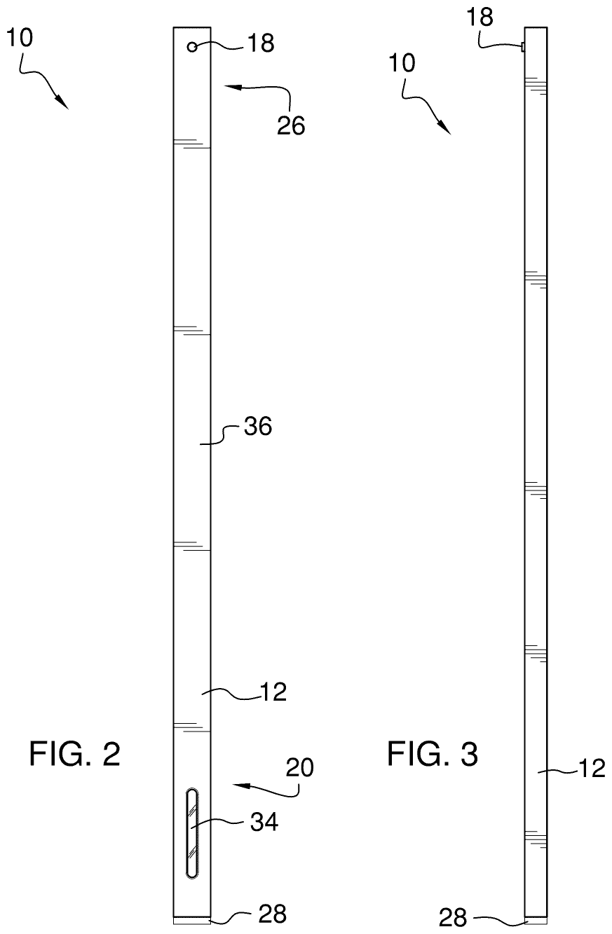

With reference now to the drawings, and in particular to FIGS. 1 through 5 thereof, a new construction grading stick embodying the principles and concepts of an embodiment of the disclosure and generally designated by the reference numeral 10 will be described.

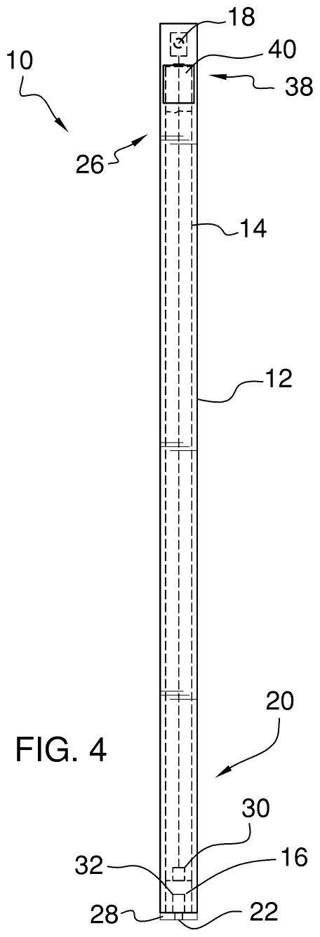

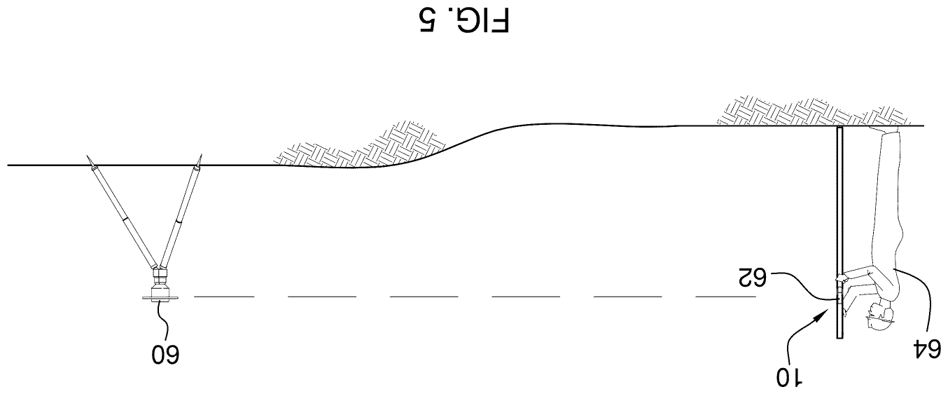

As best illustrated in FIGS. 1 through 5, the construction grading stick 10 generally comprises a housing 12, a reservoir 14, a dispenser 16, and a button 18. The housing 12 is elongated. As best seen in FIG. 4, the reservoir 14 is positioned in the housing 12 and is designed to hold a supply of marking material. Also as seen in FIG. 4, the dispenser 16 is positioned at a lower portion 20 of the housing 12. The dispenser 16 is connected to the reservoir 14 to dispense marking material from the reservoir 14. The dispenser 16 including a dispensing orifice 22 positioned in a bottom end surface 24 of the housing 12 perpendicular to a longitudinal axis of the housing 12. The button 18 is positioned at an upper portion 26 of the housing 12. The button 18 is connected to the dispenser 16 to permit selective activation of the dispenser 16 to dispense marking material out through the dispensing orifice 22 and onto a surface on which the construction grading stick 10 is vertically held.

The reservoir 14 is designed to hold a supply of chalk as marking material. In another possible embodiment, the reservoir 14 could be designed to hold other marking material, such as paint or liquid chalk.

The construction grading stick 10 further includes a rubber or plastic tip 28 about the dispensing orifice 22.

The dispenser 16 further includes a battery 30 and an electric valve 32 connected to the activation structure. The dispenser 16 can have other known designs, such as a purely mechanical dispenser 16 or a pneumatic dispenser 16.

The construction grading stick 10 further includes a window 34. The window 34 is positioned in a side wall 36 of the housing 12 and connected to the reservoir 14 to permit viewing of a level of marking material in the reservoir 14. The view window 34 is positioned at a lower portion 20 of the housing 12 and connected to a bottom of the reservoir 14. In one possible embodiment, the window 34 could extend along the length of the reservoir 14 and the housing 12.

The construction grading stick 10 further includes a refill port 38 positioned in a side wall 36 of the housing 12 to permit refilling of the reservoir 14 with marking material. The refill port 38 includes an openable and closable lid 40.

The housing 12 is in the shape of a rectangular prism. However, other shapes, such as triangular or rounded are within the scope of the disclosure.

The reservoir 14 is elongated and extends from the lower portion 20 of the housing 12 to the upper portion 26 of the housing 12.

The construction grading stick 10 can be used in a grading process where workers are trying to measure and mark different grades of surfaces at a work site. With reference to FIG. 5, in the current procedure used in the construction industry, a rotating laser 60 is mounted on a tripod at a set location. A worker then uses a stick, such as a wood 2×4 or 2×2, with a laser receiver 62 slidably positioned on the stick. The worker moves the stick to different spots of the work site, places the stick vertically, then slides the laser receiver 62 up or down the stick until the laser receiver 62 emits a steady tone indicating alignment with the laser. Another worker then marks a spot on the ground or a floor surface at the bottom tip of the stick, or the worker holding the stick tries to reach down and mark the spot. So, the procedure, as is currently done, either needs a two-person team or risk inaccuracy as one worker tries to hold a large stick in place from the bottom in one hand while trying to make a mark with another hand. In contrast, as shown in FIG. 5, one worker 64 can make the mark while standing up and holding the construction grading stick 10. The worker holds the construction grading stick 10 in a vertical position on a surface to be marked with the laser receiver 62 attached, as is normally done. However, when it is time to mark the surface under the construction grading stick 10, the worker 64 presses the button 18 and thereby activates the dispenser 16. The dispenser 16 then dispenses an amount of marking material, such as chalk or paint, and marks the surface. The present invention therefore eliminates the extra cost of another worker, allows accurate marking with one worker, and avoids having to reach down into areas to be marked that have obstacles in the way, such as rebar.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A construction grading stick comprising:
a housing being elongated;
a reservoir being disposed in said housing, said reservoir being configured to hold a supply of marking material;
a dispenser being disposed at a lower portion of said housing, said dispenser being connected to said reservoir to dispense marking material from said reservoir, said dispenser including a dispensing orifice disposed in a bottom end surface of said housing perpendicular to a longitudinal axis of said housing; and
a button being disposed at an upper portion of said housing, said button being connected to said dispenser to permit selective activation of said dispenser to dispense marking material out through said dispensing orifice and onto a surface on which the construction grading stick is being vertically held.

2. The construction grading stick of claim 1, wherein said reservoir is configured to hold a supply of chalk as marking material.

3. The construction grading stick of claim 1, wherein the construction grading stick further comprises a rubber or plastic tip about said dispensing orifice.

4. The construction grading stick of claim 1, wherein said dispenser further includes a battery and an electric valve connected to said activation structure.

5. The construction grading stick of claim 1, wherein the construction grading stick further comprises a window, said window being disposed in a side wall of said housing and connected to said reservoir to permit viewing of a level of marking material in said reservoir.

6. The construction grading stick of claim 6, wherein said view window is disposed at a lower portion of said housing and connected to a bottom of said reservoir.

7. The construction grading stick of claim 1, wherein the construction grading stick further comprises a refill port disposed in a side wall of said housing to permit refilling of said reservoir with marking material.

8. The construction grading stick of claim 7, wherein said refill port includes an openable and closable lid.

9. The construction grading stick of claim 1, wherein said housing is in the shape of a rectangular prism.

10. The construction grading stick of claim 1, wherein said reservoir is elongated and extends from said lower portion of said housing to said upper portion of said housing.

11. A construction grading stick comprising:
a housing being elongated;
a reservoir being disposed in said housing, said reservoir being configured to hold a supply of chalk;
a dispenser being disposed at a lower portion of said housing, said dispenser being connected to said reservoir to dispense chalk from said reservoir, said dispenser including a dispensing orifice disposed in a bottom end surface of said housing perpendicular to a longitudinal axis of said housing;
a button being disposed at an upper portion of said housing, said button being connected to said dispenser to permit selective activation of said dispenser to dispense chalk out through said dispensing orifice and onto a surface on which the construction grading stick is being vertically held;
a rubber or plastic tip about said dispensing orifice;
a window, said window being disposed in a side wall of said housing and connected to said reservoir to permit viewing of a level of chalk in said reservoir; and
a refill port disposed in a side wall of said housing to permit refilling of said reservoir with chalk.

12. The construction grading stick of claim 11, wherein:
said dispenser further includes a battery and an electric valve connected to said activation structure;
said view window is disposed at a lower portion of said housing and connected to a bottom of said reservoir;
said refill port includes an openable and closable lid;
said housing is in the shape of a rectangular prism; and
said reservoir is elongated and extends from said lower portion of said housing to said upper portion of said housing.

13. A method of marking a surface for construction grading, said method comprising the steps of:
providing a construction grading stick comprising:
a housing being elongated;
a reservoir being disposed in said housing, said reservoir being configured to hold a supply of marking material;
a dispenser being disposed at a lower portion of said housing, said dispenser being connected to said reservoir to dispense marking material from said reservoir, said dispenser including a dispensing orifice disposed in a bottom end surface of said housing perpendicular to a longitudinal axis of said housing; and
a button being disposed at an upper portion of said housing, said button being connected to said dispenser to permit selective activation of said dispenser to dispense marking material out through said dispensing orifice and onto a surface on which the construction grading stick is being vertically held;
holding said construction grading stick in a vertical position on a surface to be marked;
pressing said button and thereby activating said dispenser; and
dispensing an amount of marking material and marking the surface.
